(19) United States
(12) Patent Application Publication
(10) Pub. No.: US 2012/0217739 A1
(43) Pub. Date: Aug. 30, 2012

(54) APPARATUS FOR CONNECTING DOUBLE JACKETED PIPES

(76) Inventor: Karl Weinhold, Neuss (DE)

(21) Appl. No.: 13/509,474

(22) PCT Filed: Nov. 5, 2010
(86) PCT No.: PCT/EP2010/066878

§ 371 Date: May 11, 2012

(30) Foreign Application Priority Data
Nov. 12, 2009 (DE) 10 2009 052 674.9

(51) Int. Cl. F16L 39/04; B23K 31/02

(52) U.S. Cl. 285/121.2; 228/178

(57) ABSTRACT

Illustrated and described is an apparatus for connecting double jacketed pipes, comprising two fixed flanges and a locking element for connecting the fixed flanges axially; the fixed flanges respectively comprising an inner ring and an outer ring connected in a torque-proof manner to the inner ring; an inner pipe being assigned to each of the inner rings and a jacket pipe being assigned to each of the outer rings, and the fixed flanges respectively having between the inner ring and the outer ring at least one axial bore hole spaced apart from one another by an annular space. In order to achieve easy fitting of the coupling with double pipes, the pipes of which can not be displaced axially relative to one another, it is proposed to arrange an axially displaceable telescopic pipe at least between one of the outer rings and the jacket pipe assigned to it.

The invention relates to an apparatus for connecting double jacketed pipes comprising two fixed flanges and a locking element for connecting the fixed flanges axially; the fixed flanges respectively comprising an inner ring and an outer ring connected in a torque-proof manner to the inner ring; an inner pipe being assigned to each of the inner rings, and a jacket pipe being assigned to each of the outer rings, and the fixed flanges respectively having between the inner ring and the outer ring at least one axial bore hole spaced apart from one another by an annular space.

Apparatuses for connecting pipes, which are also called pipe couplings, are known in a wide variety of designs. Particularly favoured are pipe couplings with which two pipe ends can be easily connected to and released from one another again without any additional tools. Depending on the area of application of the pipelines, a wide variety of demands are made of the pipe couplings to be used.

Efficient pipe couplings should make it possible to also rotate or pivot the pipes being connected relative to one another in the installed state without this having a negative impact upon the flow through or the function of the coupling. In addition, pipe couplings should also be used in lines which are subjected to high pressures.

Pipe couplings are also used in lines in which two pipes extend substantially coaxially into one another. Such lines are known as double pipes or also as double jacketed pipes.

A generic pipe coupling for double jacketed pipes is known from DE 198 37 296 B4. The pipe coupling shown connects two ends of double pipes releaseably to one another, rotation of the two double pipes relative to one another being possible.

The pipe coupling consists of two coupling parts—often called fixed flanges—, both fixed flanges being connected to an inner and an outer pipe section and having an axial bore hole for the flow through the coupling. In order to prevent the axial bore holes from blocking the flow in a position of the flanges which is rotated unfavourably with respect to the aligned position, it is proposed that a circumferential annular groove is provided between the two fixed flanges. In this annular groove the medium flowing through the axial bore holes collects, by means of which a reliable flow through the coupling is possible in every relative position of the fixed flanges.

The known pipe couplings need to be improved, however, as regards the difficulty associated with fitting them. Double pipe couplings often consist of two parts, each of which is connected to an inner and an outer pipe before both parts are locked axially, for example with a clamp. The connection of the two coupling parts to the pipes proves to be relatively simple if the two pipes can be shifted axially in relation to one another. In this case, the inner pipes are first of all connected to the two fixed flanges.

Next the two outer pipes are pushed over the inner pipes already connected to the fixed flanges and also connected to the fixed flanges. Finally, the two fixed flanges are put together and fixed axially, for example with a coupling clamp.

However, the fitting of a double pipe coupling known from the prior art proves to be considerably more difficult and to some extent impossible if—at least on one side of the coupling—a double pipe end is to be connected to the fixed flange of the coupling with which the two pipes can not be displaced axially in relation to one another. This can often be the case in practice, for example when the double pipe end protrudes from a wall or a machine. In this case the pipe ends must be sawn off with dimensional accuracy before the fixed flange is fitted. Due to the structure, however, after the fixed flange has been fitted, only the outer pipe is still accessible. The result of this is that the connection between the fixed flange and the inner pip—for example to form a welded seam—is no longer accessible.

Therefore, the object underlying the invention is to configure and further develop the double pipe coupling specified at the start and described in more detail above so that the disadvantages known from the prior art are avoided and that in particular easy fitting of the coupling with double pipes, the pipes of which can not be displaced axially relative to one another, is possible.

This object is achieved with an apparatus for connecting double jacketed pipes according to the preamble of claim 1 in that there is positioned at least between one of the outer rings and the jacketed pipe assigned to it an axially displaceable telescopic pipe.

The telescopic pipe enables good accessibility to the inner pipe so that, for example, welds can be implemented on the inner pipe. When fitting, the telescopic pipe is first of all pushed into a fitting position on the jacket pipe assigned to it. In the next step the inner ring of the first, fixed flange on the telescopic pipe side is welded to the inner pipe assigned to it. It is irrelevant here whether the second fixed flange is already connected together with the inner and jacket pipe assigned to it to the first fixed flange or not. Finally, the telescopic pipe can be shifted axially towards the fixed flange assigned to it and be welded both to this and to the jacket pipe assigned to it. The double pipe coupling can therefore also be fitted simply on the side of the telescope pipe when the inner pipe and the jacket pipe on this side can not be displaced relative to one another in the axial direction. The telescopic pipe can in particular be in the form of a one-part casing. Alternatively, the telescopic pipe can be made of a number of pipes or casings that can be moved into one another like a telescope and be shifted axially in relation to one another.

It is possible for the double pipe coupling to have a telescopic pipe on each side of the coupling or also on both sides at the same time. If a double pipe coupling with a telescopic pipe on both sides is used, the double pipe coupling can also be fitted easily in the way described if the inner pipe and the jacket pipe can not be displaced relative to one another in the axial direction on any side of the coupling. In this case, the distance between the ends of the inner pipes is only to be chosen or set so that in the assembled state the two fixed flanges can be inserted, fitting accurately, between the ends of the inner pipes. The fixed flanges are preferably produced from cast steel.

In pipeline systems with a number of double pipe couplings, between which relatively long, for example several metres long, double jacketed pipes are fitted, it is proposed that spacers, which—comparably to the fixed flanges—space the two pipes radially, are attached defined distances apart between the inner pipes and the jacket pipes.

A relative rotation of the pipe ends to be connected is achieved according to a further configuration of the invention by the two fixed flanges being rotatably connected to one another. Such a double pipe coupling makes it possible, even after closing with the locking element, for the pipe piece welded onto the one fixed flange to rotate easily about its axis towards the adjacent pipe piece welded onto the opposite fixed flange. This is necessary in some cases, e.g. for aligning a fitting or when rotating pipeline sections. The relative movement between the fixed flanges can in particular be achieved by using lubricants and/or by using sliding or rolling bearings.

According to a further configuration of the invention the fitting proves to be particularly easy by the telescopic pipe being disposed with axial displaceability on the outside of the jacket pipe assigned to it.

The advantage of the arrangement of the telescopic pipe on the outside of the jacket pipe assigned to it in comparison to an arrangement lying on the inside is that the telescopic pipe can be reached easily by hand or with a tool and can be displaced. In addition, the inner diameter of the jacket pipe affecting the flow characteristics is not reduced by an arrangement of the telescopic pipe lying on the outside of the jacket pipe.

In a further configuration of the invention it is proposed that the locking element connects the fixed flanges rotatably, fixes them axially, and is in the form, for example, of a clamp, cap nut or bead chain.

A clamp can often be actuated manually by a tension lever connected to a spring, and is characterised by easy and fast fitting and removal without using any additional tools (so-called quick coupling). Consequently, savings can be made on staff costs.

No additional (striking) tools are required either when using a cap nut. Therefore, the connection can be screwed together and released by hand. Retensioning after screwing on the cap nut is generally not required. Often the threaded part and the cap nut have a conical thread with a cylindrical runout. In addition, a cotter pin can be provided that prevents undesired unscrewing and increases the operational reliability of the double pipe coupling. The cap nut can easily be unfastened again, in particular if radial blind holes are moulded into the cap nut from the outside, even after a long operating period.

By using a bead chain for axial locking, a particularly small amount of abrasion between the fixed flanges can be achieved, by means of which they can rotate easily relative to one another. A coupling with a bead chain is known in its own right from DE 33 24 271 A1.

In order to seal the double pipe coupling better a further configuration of the invention makes provision such that a ring seal is positioned between the inner ring of the one fixed flange and the inner ring of the other fixed flange and/or between the outer ring of the one fixed flange and the outer ring of the other fixed flange. The advantage of using a ring seal is that an outstanding sealing effect can also be achieved with a relative movement between the surfaces to be sealed. The ring seal can in particular be a radial wave sealing ring.

According to further teaching of the invention, provision is made such that there is positioned rotatably between the fixed flanges a double nipple which has an inner ring and an outer ring connected in a torque-proof manner to the inner ring. The use of a double nipple makes it possible to design the two fixed flanges identically. The advantage of this, above all in the casting production of fixed flanges, for example by steel casting, is that only one casting mould need be used. In this way the fixed flanges can be produced in a more economical fashion. The double pipe coupling can have a double nipple with any type of lock, in particular with axial locking by means of a clamp, cap nut or bead chain.

According to one advantageous configuration, a better seal is achieved by at least one ring seal respectively being positioned between the inner ring of the fixed flange and the inner ring of the double nipple and/or between the outer ring of the fixed flange and the outer ring of the double nipple. Here too, the advantage of using a ring seal is that an outstanding sealing effect can also be achieved with a relative movement between the surfaces to be sealed. The ring seal can in particular be a radial shaft sealing ring.

Further teaching of the invention makes provision such that the flow cross-section formed by the annular space and the axial bore holes for connecting the jacket annular spaces at each point is greater than the cross-sectional area of the inner pipes. In this way it is guaranteed that the flow of the jacket annular spaces can flow with low resistance. This is particularly important when the jacket annular spaces form a return line the pressure of which is less than the pressure in the high pressure feed line lying on the inside.

Finally, it is proposed in a further configuration of the invention for the inner pipes to be configured as a high pressure feed line and the jacketed pipes to be configured as a return line for use in underground mining. By using double pipelines, when laying the space for an additional line can be saved in comparison to individual pipelines lying next to one another, and this is particularly advantageous in restricted spatial circumstances, for example underground. It is therefore proposed to preferably produce the high pressure feed lines and return lines for the water hydraulic system in coal mining as a double pipeline.

In the high pressure feed line an operating pressure of approximately 40 MPa prevails, whereas the return line is operated at approximately 4-7 MPa. Also due to the different pressures double pipelines are also an option for this application because the wall thickness of the inner high pressure line can be chosen independently of the wall thickness of the outer low pressure or return line. For the proposed application this can mean that the wall thickness of the inner pipes is greater than the wall thickness of the jacketed pipes.

In addition, the underground use of a double jacketed pipe offers the advantage that if the more greatly stressed inner pipe is not tight—due to the higher pressure—, the jacket pipe lying on the outside prevents the fluid from passing immediately out of the double jacketed pipe. This reduces the risk of injury, and particularly in mining unnecessary repairs at locations difficult to access can thus be avoided.

In the following the invention is described in greater detail by means of drawings only illustrating preferred exemplary embodiments.

The drawings show as follows:

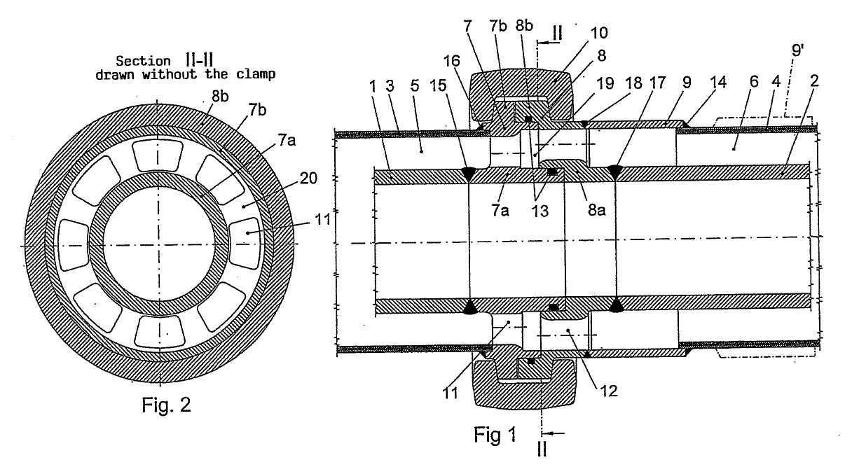

FIG. 1 a longitudinal section of a double pipe coupling with a clamp as an axial locking element,

FIG. 2 a cross-section of the object of FIG. 1 along the line II-II, drawn without a clamp,

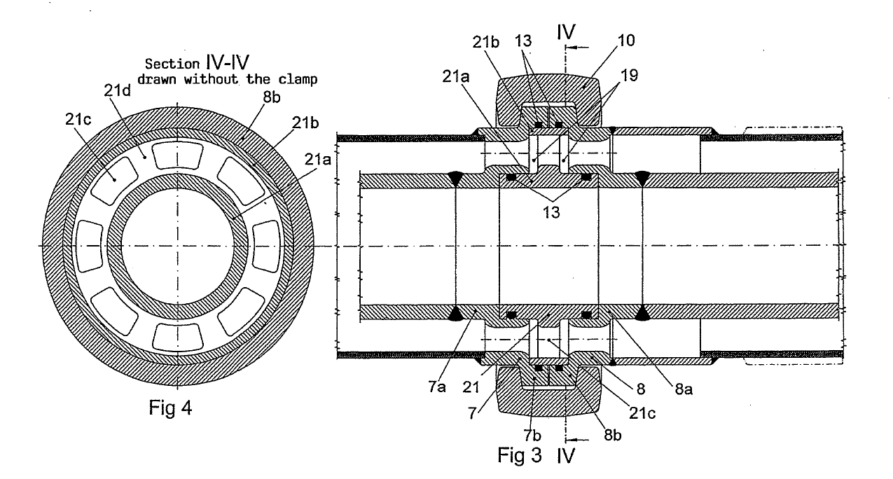

FIG. 3 a longitudinal section of a double pipe coupling with a clamp as an axial locking element and a double nipple,

FIG. 4 a cross-section of the object of FIG. 3 along the line IV-IV, drawn without a clamp,

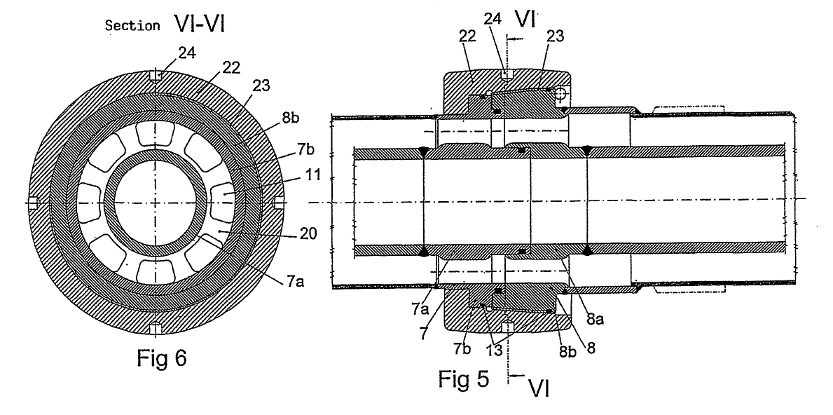

FIG. 5 a longitudinal section of a double pipe coupling with a cap nut and a thread as an axial locking element,

FIG. 6 a cross-section of the object of FIG. 5 along the line VI-VI,

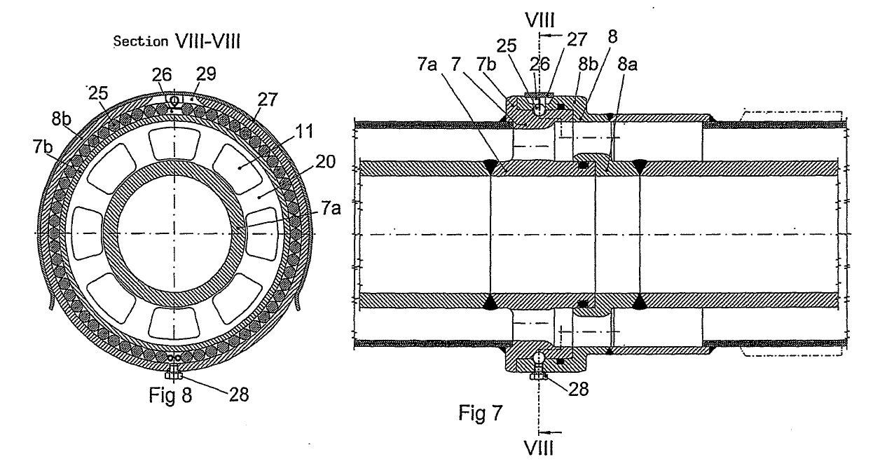

FIG. 7 a longitudinal section of a double pipe coupling with a divided bead chain as an axial locking element, and

FIG. 8 a cross-section of the object of FIG. 7 along the line VIII-VIII.

FIG. 1 shows an apparatus for connecting double jacketed pipes which is also called a double pipe coupling in the following. The double pipe coupling shown connects on the one hand inner pipes 1, 2 and on the other hand jacket pipes 3, 4 lying on the outside. The inner pipes 1, 2 and the jacket pipes 3, 4 are arranged substantially collinearly so that a jacket annular space 5 is formed between the inner pipe 1 and the jacket pipe 3, and a jacket annular space 6 is formed between the inner pipe 2 and the jacket pipe 4. The double pipe coupling shown in FIG. 1 and in this respect preferred, has a fixed flange 7 with an inner ring 7a and an outer ring 7b as well as a second fixed flange 8 with an inner ring 8a and an outer ring 8b. In addition, the double pipe coupling shown has a telescopic pipe 9 which connects the outer ring 8b of the fixed flange 8 to the jacket pipe 4. The telescopic pipe 9 is pushed into a fitting position 9b for fitting.

The two fixed flanges 7, 8 are fixed in an axial direction in the double pipe coupling of a clamp 10 shown in FIG. 1. The connection established in this way by the clamp 10 enables rotation of the two fixed flanges 7, 8 relative to one another. The fixed flange 7 has between its outer ring 7b and its inner ring 7a at least one axial bore hole 11. Similarly, an axial bore hole 12 is formed between the inner ring 8a and the outer ring 8b of the fixed flange 8.

In the double pipe coupling shown in FIG. 1, the two fixed flanges 7, 8 are pushed onto one another axially. A tight connection is thereby produced by ring seals 13 both between the inner rings 7a, 8a and between the outer rings 7b, 8b. The connection between the jacket pipe 4 and the telescopic pipe 9 is formed by a weld seam 14. The connections between the inner pipe 1 and the inner ring 7a, and the jacket pipe 3 and the outer ring 7b are also produced by weld seams 15 and 16. The inner pipe 2 and the inner ring 8a are joined by a weld seam 17, whereas the telescopic pipe 9 is connected to the outer ring 8b by a weld seam 18.

The axial bore holes 11, 12 enable connection of the jacket annular spaces 5, 6. In the case where the axial bore holes 11, 12 are not arranged collinearly in relation to one another, there is a risk that the connection between the jacket annular space 5 and the jacket annular space 6 will be blocked. For this reason the axial bore hole 11 is spaced apart from the axial bore hole 12 by a circumferential annular space 19. It is guaranteed by the annular space 19 that the axial bore holes 11, 12 form a sufficient connection between the jacket annular spaces 5, 6 in any rotated position of the fixed flanges 7, 8.

In the double pipe coupling shown in FIG. 1, the jacket pipe 4 and the telescopic pipe 9 are formed such that the telescopic pipe 9 is arranged axially displaceably on the jacket pipe 4. The telescopic pipe 9′ pushed back into the fitting position makes it possible to make the required welds on the inner pipes 1, 2. In the double pipe coupling shown in FIG. 1, the join between the inner pipe 2 and the inner ring 8a with the telescopic pipe 9′ pushed back into the fitting position is particularly easily accessible, and so the circumferential weld seam 17 can be welded easily. After the welding of the inner pipes 1, 2, the telescopic pipe 9 is pushed back towards the double pipe coupling so that the telescopic pipe 9 touches the outer ring 8b. In this position the telescopic pipe 9 can be connected to the jacketed pipe 4 by the weld seam 14; in addition, the telescopic pipe 9 can be connected to the outer ring 8b by the weld seam 18. Correspondingly, a telescopic pipe 9 can also be provided at the same time on the other side of the double pipe coupling or on both sides of the double pipe coupling in order to simplify the welding of the inner pipes 1, 2.

FIG. 2 shows a cross-section along line II-II of the double pipe coupling of FIG. 1. For reasons of clarity the clamp 10 is left out in FIG. 2. The inner ring 7a is shown right on the inside in FIG. 2. On the very outside is the outer ring 8b which is assigned to the outer ring 7b with its inside. The inner ring 7a is connected in a torque-proof manner to the outer ring 7b by a number of bars 20. Axial bore holes 11 are formed between the bars 20.

FIG. 3 shows a longitudinal section of a further configuration of the double pipe coupling. Unlike the double pipe coupling known from FIG. 1, the embodiment of the double pipe coupling shown in FIG. 3 has a double nipple 21 which is disposed between the fixed flanges 7, 8. The double nipple 21 has an inner ring 21a and an outer ring 21b. Axial bore holes 21c, which are formed between the inner ring 21a and the outer ring 21b, enable penetrability of the double nipple 21 in the axial direction. Arranged between the axial bore holes 21c are bars 21d which connect the inner ring 21a and the outer ring 21b to one another in a torque-proof manner.

An annular space 19 is respectively formed both between the fixed flange 7 and the double nipple 21, and between the fixed flange 8 and the double nipple 21. As already described above, the annular spaces 19 enable penetrability of the double pipe coupling in the axial direction independently of the rotational position of the fixed flanges 7, 8 relative to one another. In order to guarantee reliable sealing of the double pipeline, it is proposed to dispose a ring seal 13 respectively between the outer ring 21b and the outer ring 7b, and between the outer ring 21b and the outer ring 8b. Similarly, a ring seal 13 is respectively disposed between the inner ring 7a and the inner ring 21a, and between the inner ring 8a and the inner ring 21a.

In FIG. 4 the object of FIG. 3 is shown as a cross-section along line IV-IV. For reasons of clarity, the clamp 10 is not illustrated either in FIG. 4. The outer ring 8b is shown radially on the outside. Assigned to the latter is the outer ring 21b of the double nipple 21. The inner ring 21a of the double nipple 21 is shown radially on the inside. There are provided between the inner ring 21a and the outer ring 21b both axial bore holes 21c for the axial penetrability of the double nipple 21 and bars 21d for the torque-proof connection between the inner ring 21a and the outer ring 21b.

FIG. 5 shows a longitudinal section of a further configuration of the double pipe coupling in which a cap nut 22 instead of a clamp is used as an axial locking element. The cap nut 22 and the outer ring 8b interact by means of a thread 23. In order to simplify the fitting, blind bore holes 24 are provided in the cap nut 22. The outer ring 7b is locked axially between the cap nut 22 and the outer ring 8b. Nevertheless, the fixed flange 7 can be rotated relative to the cap nut 22 and the fixed flange 8 so that the embodiment of the double pipe coupling shown in FIG. 5 can also produce a rotatable connection of two double pipes. For the design of a rotatable connection it is necessary to cut a thread 23 in just one of the two outer rings 7b, 8b in order to interact with the cap nut 22. Ring seals 13 are provided both between the outer ring 7b and the cap nut 22, and between the outer ring 8b and the cap nut 22.

FIG. 6 shows the object of FIG. 5 in a cross-section along line VI-VI. The cap nut 22 is shown radially on the outside into which four blind bore holes 24 are made in order to facilitate fitting. The cap nut 22 is connected to the outer ring 7b by a thread 23. The outer ring 7b is positioned within the outer ring 8b. The inner ring 7b, which is connected in a torque-proof manner to the outer ring 7b by bars 20 lies radially on the inside. In addition, axial bore holes 11 are provided between the inner ring 7a and the outer ring 7b.

A further configuration of the double pipe coupling is shown in the longitudinal section in FIG. 7. This configuration provides a bead chain 25 as an axial locking element. A common circumferential groove 26 is made in the outer ring 7b and in the outer ring 8b. The bead chain 25, which prevents axial displacement between the fixed flange 7 and the fixed flange 8, is placed in the groove 26. The insertion and withdrawal of the bead chain 25 proves to be particularly easy because a divided bead chain 25, i.e. a bead chain 25 with two loose ends, is used. The chain links can be spheres, discs, cylinders or the like. The bead chain 25 enables rotation between the fixed flange 7 and the fixed flange 8. In order to prevent the bead chain 25 from falling out or being withdrawn, the groove 26 is covered by a protective brace 27, a lubrication nipple 28 remaining accessible.

FIG. 8 shows the object of FIG. 7 in a cross-section along the line VIII-VIII. The protective brace 27, which partially encloses the outer ring 8b, is shown radially on the outside. The bead chain 25 is arranged in the groove 26 between the outer ring 8b and the outer ring 7b. During fitting, the bead chain 25 is introduced into the groove 26 through a recess 29 made in the outer ring 8b and also covered by the protective brace 27. In order to deliver lubricant, in particular lubricating grease, into the groove 26, a lubrication nipple 28 is provided which, in the exemplary embodiment shown, is disposed diametrically opposite the recess 29.

1-11. (canceled)

12. An apparatus for connecting double jacketed pipes, comprising two fixed flanges (7, 8) and a locking element (10, 22, 25) for connecting the fixed flanges (7, 8) axially;
the fixed flanges (7, 8) respectively comprising an inner ring (7a, 8a) and an outer ring (7b, 8b) connected in a torque-proof manner to the inner ring (7a, 8a);
an inner pipe (1, 2) being assigned to each of the inner rings (7a, 8a), and a jacket pipe (3, 4) being assigned to each of the outer rings (7b, 8b),
the fixed flanges (7, 8) respectively having between the inner ring (7a, 8a) and the outer ring (7b, 8b) at least one axial bore hole spaced apart from one another by an annular space (19), and
the two fixed flanges (7, 8) being connected to one another rotatably
characterised in that
there is positioned at least between one of the outer rings (7b, 8b) and the jacket pipe (3, 4) assigned to it a telescopic pipe (9), that is disposed with axial displaceability on the jacket pipe (3, 4) assigned to it, so that in a fitting position of the telescope pipe (9) the inner pipe is easily accessible.

13. The apparatus according to claim 1, characterised in that the telescopic pipe (9) is disposed with axial displaceability on the outside of the jacket pipe (3, 4) assigned to it.

14. The apparatus according to claim 2, characterized in that the telescopic pipe (9) is welded to the jacket pipe (3, 4) assigned to it and the outer ring (7b, 8b).

15. An apparatus for connecting double jacketed pipes, comprising two fixed flanges (7, 8) and a locking element (10, 22, 25) for connecting the fixed flanges (7, 8) axially;
the fixed flanges (7, 8) respectively comprising an inner ring (7a, 8a) and an outer ring (7b, 8b) connected in a torque-proof manner to the inner ring (7a, 8a);
an inner pipe (1, 2) being assigned to each of the inner rings (7a, 8a), and a jacket pipe (3, 4) being assigned to each of the outer rings (7b, 8b),
the fixed flanges (7, 8) respectively having between the inner ring (7a, 8a) and the outer ring (7b, 8b) at least one axial bore hole spaced apart from one another by an annular space (19), and
the two fixed flanges (7, 8) being connected to one another rotatably
characterised in that
there is positioned at least between one of the outer rings (7b, 8b) and the jacket pipe (3, 4) assigned to it a telescopic pipe (9), that is disposed with axial displaceability on the jacket pipe (3, 4) assigned to it, so that in a fitting position of the telescope pipe (9) the inner pipe is easily accessible and in that the telescopic pipe (9) is welded to the jacket pipe (3, 4) assigned to it and the outer ring (7b, 8b).

16. The apparatus according to claim 4, characterised in that the locking element (10, 22, 25) connects the fixed flanges (7, 8) rotatably, fixes them axially, and is in the form of a clamp (10), a cap nut (22) or a bead chain (25).

17. The apparatus according to claim 4, characterised in that a ring seal (13) is positioned between the inner ring (7a) of the one fixed flange (7) and the inner ring (8a) of the other fixed flange (8) and/or between the outer ring (7b) of the one fixed flange (7) and the outer ring (8b) of the other fixed flange (8).

18. The apparatus according to claim 1, characterised in that a ring seal (13) is positioned between the inner ring (7a) of the one fixed flange (7) and the inner ring (8a) of the other fixed flange (8) and/or between the outer ring (7b) of the one fixed flange (7) and the outer ring (8b) of the other fixed flange (8).

19. The apparatus according to claim 3, characterised in that a ring seal (13) is positioned between the inner ring (7a) of the one fixed flange (7) and the inner ring (8a) of the other fixed flange (8) and/or between the outer ring (7b) of the one fixed flange (7) and the outer ring (8b) of the other fixed flange (8).

20. The apparatus according to claim 1, characterised in that there is positioned rotatably between the fixed flanges (7, 8) a double nipple (21) which has an inner ring (21a) and an outer ring (21b) connected in a torque-proof manner to the inner ring (21b).

21. The apparatus according to claim 3, characterised in that there is positioned rotatably between the fixed flanges (7, 8) a double nipple (21) which has an inner ring (21a) and an outer ring (21b) connected in a torque-proof manner to the inner ring (21b).

22. The apparatus according to claim 4, characterised in that there is positioned rotatably between the fixed flanges (7, 8) a double nipple (21) which has an inner ring (21a) and an outer ring (21b) connected in a torque-proof manner to the inner ring (21b).

23. The apparatus according to claim 9, characterised in that at least one ring seal (13) is respectively positioned between the inner ring (7a, 8a) of the fixed flange (7, 8) and the inner ring (21a) of the double nipple (21) and/or between the outer ring (7b, 8b) of the fixed flange (7, 8) and the outer ring (21b) of the double nipple (21).

24. The apparatus according to claim 10, characterised in that at least one ring seal (13) is respectively positioned between the inner ring (7a, 8a) of the fixed flange (7, 8) and the inner ring (21a) of the double nipple (21) and/or between the outer ring (7b, 8b) of the fixed flange (7, 8) and the outer ring (21b) of the double nipple (21).

25. The apparatus according to claim 11, characterised in that at least one ring seal (13) is respectively positioned between the inner ring (7a, 8a) of the fixed flange (7, 8) and the inner ring (21a) of the double nipple (21) and/or between the outer ring (7b, 8b) of the fixed flange (7, 8) and the outer ring (21b) of the double nipple (21).

26. The apparatus according to claim 4, characterised in that the flow cross-section formed by the annular space (19) and the axial bore holes (11, 12) for connecting the jacket annular spaces (5, 6) at each point is greater than the cross-sectional area of the inner pipes (1, 2).

27. The apparatus according to claim 4, characterised in that the inner pipes (1, 2) are configured as a high pressure feed line and the jacket pipes (3, 4) are configured as a return line for use in underground mining.

28. Method for connecting double jacketed pipes that each comprise an inner pipe (1, 2) and a jacket pipe (3, 4), by means of an apparatus for connecting double jacketed pipes comprising two fixed flanges (7, 8) and a locking element (10, 22, 25) for connecting the fixed flanges (7, 8) axially and rotatably, the fixed flanges (7, 8) respectively comprising an inner ring (7a, 8a) and an outer ring (7b, 8b) connected in a torque-proof manner to the inner ring (7a, 8a), the fixed flanges (7, 8) respectively having between the inner ring (7a, 8a) and the outer ring (7b, 8b) at least one axial bore hole spaced apart from another by an annular space (19), wherein each of the inner rings (7a, 8a) is connected with an inner pipe (1, 2) assigned thereto and each of the outer rings (7b, 8b) with a jacket pipe (3, 4) assigned thereto of the double jacketed pipes, characterized in that at least between one of the outer rings (7b, 8b) of a fixed flange (7, 8) and the jacket pipe (3, 4) assigned thereto a telescopic pipe (9) is positioned, that is disposed with axial displaceability on the jacket pipe (3, 4), the telescopic pipe is displaced on the jacket pipe (3, 4) away from the fixed flange (7, 8) into a fitting position, in a next step the inner ring (7a, 8a) of the fixed flange (7, 8) is welded to the inner pipe (1, 2) assigned thereto, the telescopic pipe (9) is displaced towards the fixed flange (7, 8) and finally the telescopic pipe (9) is welded to the outer ring (7b, 8b) of the fixed flange (7, 8) as well as to the jacket pipe (3, 4) assigned thereto.

29. Method according to claim 17, characterized in that the telescopic pipe (8) is disposed with axial displaceability on the outside of the jacket pipe (3, 4) assigned to it.
